(19) United States
(12) Patent Application Publication
(10) Pub. No.: US 2003/0140314 A1
(43) Pub. Date: Jul. 24, 2003

(54) IMAGE INFORMATION SERVER FOR STORING IMAGE INFORMATION

(76) Inventor: KOHJI TAKAHARA, YOKOHAMA-SHI (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 09/330,056

(22) Filed: Jun. 11, 1999

(30) Foreign Application Priority Data
Jun. 11, 1998 (JP) 10-179731

(51) Int. Cl. G06F 17/21

(52) U.S. Cl. 715/517

(57) ABSTRACT

A network system includes a plurality of client terminal computers connected to a network, an image information server connected to the network, which stores image information, and an image input device, e.g. a scanner, connected to the image information server, which inputs image information to be stored in the image information server. An image information determining device determines if the image information read by the scanner is related to format image information, which may include user information or user group information. An image information storing device executes a storing operation of the image information in the image information server based on the format image information, i.e., the user information or user group information.

### BACKGROUND OF THE INVENTION

1. Field of the Invention

This invention relates to an information server connected to a network together with user client computers, and which separately stores information for each user. In particular, the present invention relates to an information on server which is convenient when using an image input device, e.g. a scanner, at a location away from the information server.

2. Discussion of the Background

Recently, a plurality of client terminal devices, such as personal computers, are employed in an office, and a network system for communicating, e.g. by electronic mail, among the client terminal devices is becoming increasingly employed therein. In such a network system, a plurality of client terminal devices generally use a common printer and a common file server.

As illustrated in Japanese Patent Application Laid Open Number 08-6877, an image information inputting apparatus is commonly used in a network system. Namely, as illustrated in FIG. 10, a plurality of first information dealing apparatuses (client terminal apparatuses) 21, a second information dealing apparatus 22 including an image information inputting device, such as a scanner, and a third information dealing apparatus 23, such as a file server, are connected to a commonly used data transmission line 24.

Further, when the first information dealing apparatus 21 requests image information from the third image information dealing apparatus 23, and if the image information requested by the first information dealing apparatus 21 as an information transfer destination has been input to be stored in the third image information dealing apparatus 23, the requested image information is transferred from the third image information dealing apparatus 23 to the first information dealing apparatus 21. Further, if the requested image requested image information has not been input to be stored in the third image information dealing apparatus 23, the information can be transferred to the first information dealing apparatus 23 after such input has been made therein.

According to the published specification of the Japanese Patent Application Laid Open Number 8-102837, an image information inputting device is illustrated, and image information stored in a storing section is transferred to a client terminal device through a network, which has an address input by an operator through a keypad. Further, an image information server, to which a scanner is connected, is commonly used by a plurality of client computers.

Further, the below mentioned system has been proposed. Namely, in the system, image information from one or more documents is read by a scanner, and the read image information is stored in an image information server. A user name is attached to the corresponding image information by operating an image information inputting apparatus at a location apart from the image information server in a prescribed manner so that the image information can be read by one or more users having the user name. Thus, a client terminal device can read the image information stored in the image information server by designating the user name.

However, in such a background system, an operator is required to execute input operations of both the user name and image information by going to and returning from the image information server and the image information inputting apparatus. Further, whenever inputting the image information, a user name and so on are always required to be correspondingly input by the operator using a keypad.

### SUMMARY OF THE INVENTION

Accordingly, an object of the present invention is to provide a novel image information server system which is convenient for a user to use.

A further object of the present invention is to provide a novel image information server system which overcomes the drawbacks in the background art as discussed above.

A more specific object of the present invention is to provide a novel network system including a plurality of user client terminal devices connected to a network, an image information server connected to the network, which stores image information for each user, and an image reading device, e.g. a scanner, connected to the image information server, which inputs document image information to be stored in the image information server and format image information.

The network system may further include an image information determining device which determines if the image information read by the scanner includes format image information including user information or user group information, and an image information storing device which executes a storing operation of the document image information in the image information server corresponding either to the user information or user group information.

In another embodiment, the image information storing device may execute a storing operation of image information having a plurality of pages of original documents in the image information storing device as one image file.

In yet another embodiment, the image information determining device may determine if the format image information read by the scanner is either related to document start information or document end information, and the image information storing device may execute a storing operation of image information read from original documents during a time period between reading operations for the document start information and document end information as one image file.

In yet another embodiment, the image information determining device may determine if format image information read by the scanner includes document end information, and the image information storing device may execute a storing operation of image information read from original documents during a time period between reading operations for the user information or the user group information and the document end information as one image file.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block chart that illustrates an outline of an image information server of the present invention, which is employed in a network system;

FIG. 2 is a flowchart that illustrates a first example of an operation of the information storing server illustrated in FIG. 1;

FIG. 3 is a chart that illustrates a format image sheet having a mark, which is read before original documents are read by a scanner in the first example of FIG. 2;

FIG. 4 is a chart that illustrates a construction of data stored in a portion of the image information server of the first example of FIG. 2;

FIG. 5 is a flowchart that illustrates a second example of an operation of the image information server employed in a network system;

FIG. 6 is a chart that illustrates a construction of data stored in a portion of the image information server of the second example of FIG. 5;

FIG. 7 is a flowchart that illustrates a third example of an operation of the image information server employed in a network system;

FIG. 8 is a chart that illustrates a format image sheet to be read by a scanner after original documents have been read, which is used in the third example of FIG. 7;

FIG. 9 is a chart that illustrates a network system including the image information server of the present invention; and

FIG. 10 is a chart that illustrates a background network system.

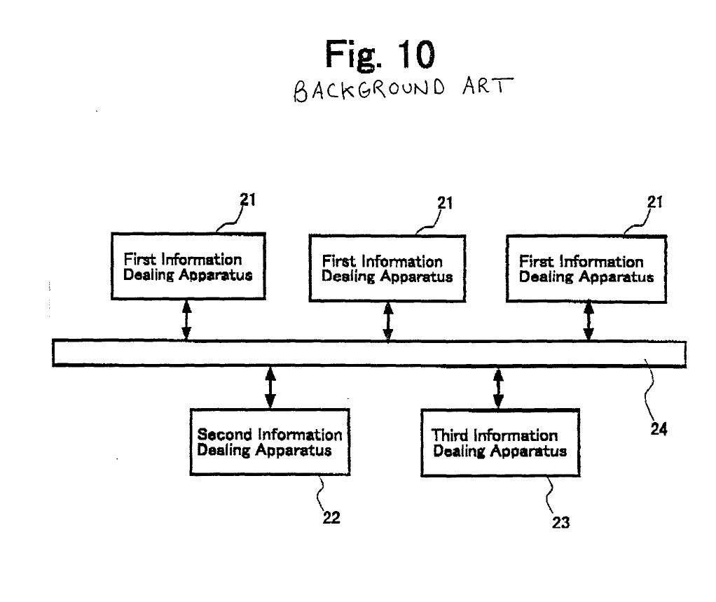

### DETAILED DESCRIPTION OF THE PREFERRED EMBODIMENTS

The embodiments of the present invention are now explained referring to the drawings, in which like reference numerals and marks indicate identical or corresponding parts throughout the several views.

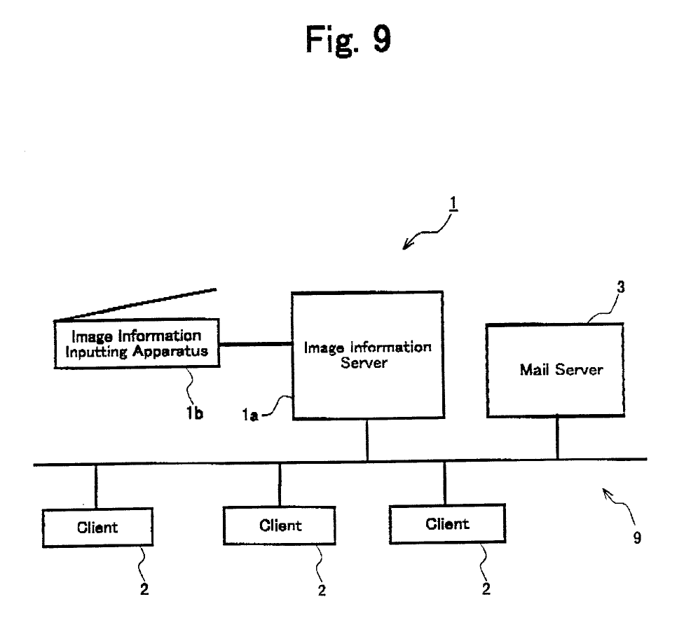

FIG. 9 illustrates a constitution of a network system of the present invention, which includes an image information server unit 1 having various modifications as mentioned below. As illustrated therein, an image information server unit 1 may include an image information server (hereinafter referred to as an information server) 1a, and an image information inputting apparatus 1b, such as a scanner, disposed external of the information server 1a and which is connected thereto by, e.g., a cable. The information server la may be connected to a transmission line 9, for example. A plurality of client terminal devices 2 and a mail server 3 and so on may also be connected to the transmission line 9. Each client 5 terminal device 2 may read image information stored in the image information server 1 a and send electronic mail having image information to a prescribed terminal device or devices disposed within a wide range network via the mail server 3.

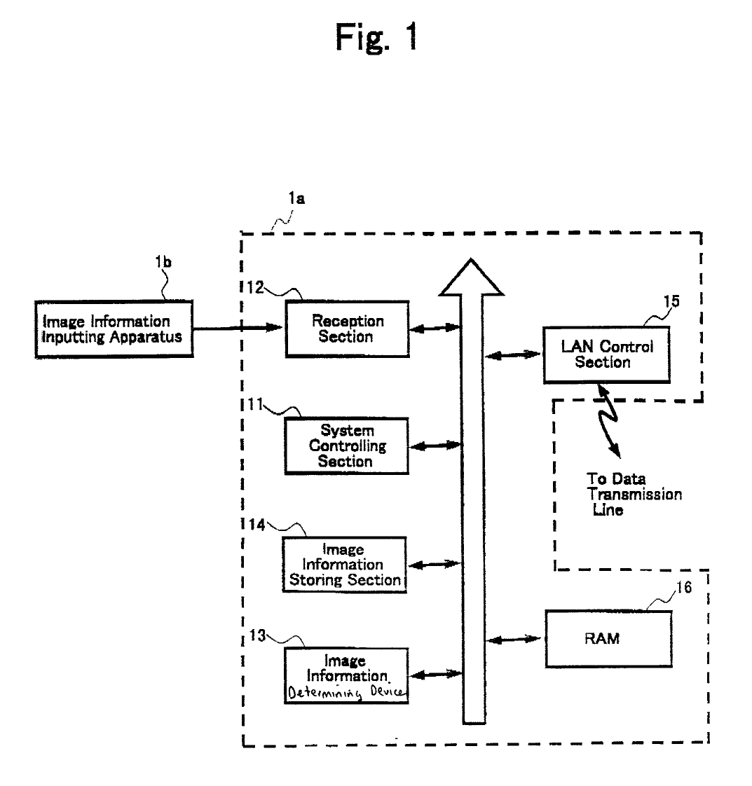

FIG. 1 illustrates the image information server 1 a in greater detail. As illustrated in FIG. 1, the information server 1a may include a system controlling section 11 for controlling the information server 1a, an information reception section 12 for receiving image information or the like sent from the image information inputting device 1b, and an image information determining device 13 for determining if user information or the like read by the image information inputting device 1b includes format image information.

The information server 1 a may further include an image information storing section 14 for storing image information read by the image information inputting device 1b. A local area network (hereinafter referred to as a LAN) controlling section 15 may be provided to control data communication executed between the client terminal computers 2 connected to the transmission line 9, and a random access memory (hereinafter referred to as a RAM) 16 may be provided in the information server 1a.

The system controlling section 11 may further include a read only memory (not shown, hereinafter referred to as a ROM) for storing programs therein and a central processing unit (not shown, hereinafter referred to as a CPU). Thus, the system controlling section 11 may function as an image information storing device for executing storing of image information in the image information storing section 14. The image information storing section 14 may further include a large capacity memory such as a hard disc, an optical disc, etc. (not shown). The image information inputting device 1b may be connected to the information server 1a by a cable having a length of from several meters to ten and so meters, or may communicate therewith in a wireless state.

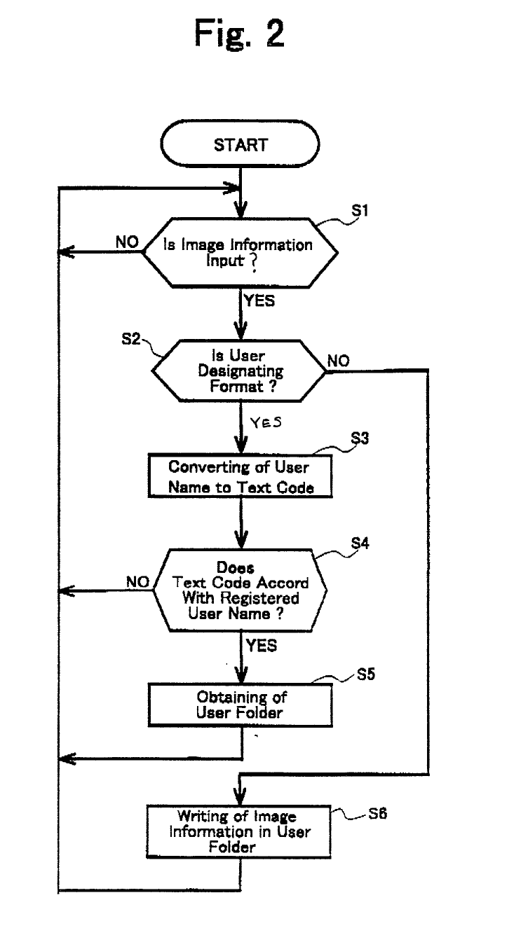

Hereinbelow, a first example of an operation in the present invention is explained referring to FIG. 2, which details a control operation executed by the system controlling section 11. As illustrated in FIG. 2, in a first step S1 the system controlling section 11 monitors input of image information through the image information inputting device 1b during a waiting time in which it is, for example, determined whether image information has been input by, e.g., a scanner and registered in the image information server 1a.

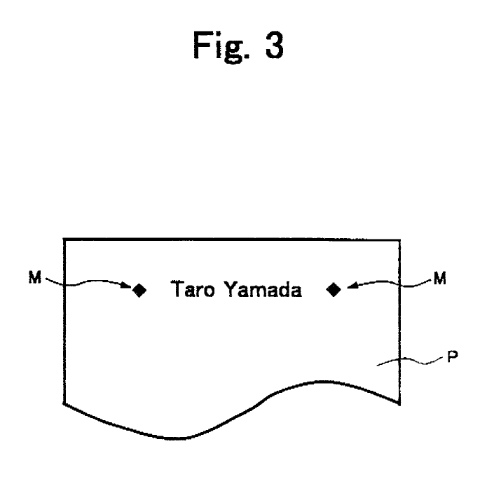

During the waiting time, a user may set on the image information inputting device 1b both (1) a format image sheet P having a user name as illustrated in FIG. 3 as a first page of a stack of original documents and (2) one or more original documents successively attached to the format image sheet P. An image information inputting operation is started by depressing a start key provided on the image information inputting device 1b. A pair of marks M illustrated in FIG. 3 may indicate that a user name is between the marks M, although clearly other marking systems may be utilized.

When the system controlling section 11 receives input image information in step S1, i.e. Yes in step S1, the system controlling section 11 may transfer the input image information to the image information determining section 13 so that the image information determining section 13 may, in step S2, determine if the marks M are included in the input image information.

If the system controlling section 11 receives information indicating the marks M, i.e. YES in step S2, it may determine that the image information includes format image information describing the user name and then order the image information determining section 13 to recognize the name of the user. The image information determining section 13 may then recognize the user name using, e.g., a conventional character recognizing method, and then in step S3 convert the user information obtained to a corresponding text code. The image information determining section 13 may thereafter transfer the text code to the system controlling section 11.

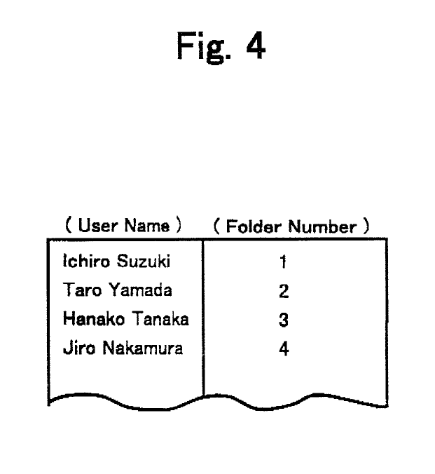

In step S4 the system controlling section 11 may determine if the above-mentioned user name has been registered. A plurality of user names may have previously been registered in a user table corresponding to folder numbers as illustrated in FIG. 4, and such a user table may have been copied from, e.g., a hard disk constituting the image information storing section 14 to the RAM 16. Thus, the system controlling section 11 may execute the determination in step S4 by retrieving a prescribed user name from the user table. If it is determined that the user name has been registered in step S4, i.e. Yes in step S4, the system controlling section 11 may obtain a folder number allocated to the user name from the user table in step S5, and the process may return to step S1 after storing the folder number in a prescribed area of the RAM 16. If it is determined that the user name has not been registered in step S4, i.e. No in step S4, a mark indicating a result of such a determination may be displayed on a display (not shown), and the process may return to step S1.

After the operation returns to step S1 after reading the format information sheet P, image information of the original document following the format information sheet P is read.

At this time, since the format information sheet P including the mark M has already been read, the mark M is not detected by the system controlling section 11 in step S2, i.e. No in step S2, which then indicates that the read image information is original document information to be stored in the information server 1a. The operation then proceeds to step S6 in which the system controlling section 11 may thereafter store the image information in an area of the image information storing section 14 which corresponds to the folder number, by referring to the obtained folder number.

A user may then operate the client terminal device 2 to read image information stored in a prescribed folder having a prescribed folder number corresponding to a user name by designating the user name or folder number.

Thus, according to the first example, it is not required for the user to go to and return from the information server 1a and the image information inputting device 1b, which may be located apart from the information server 1a, or to go between the client terminal device 2 and the image information inputting device 1b. Further, a key depressing operation for inputting the user name is not required.

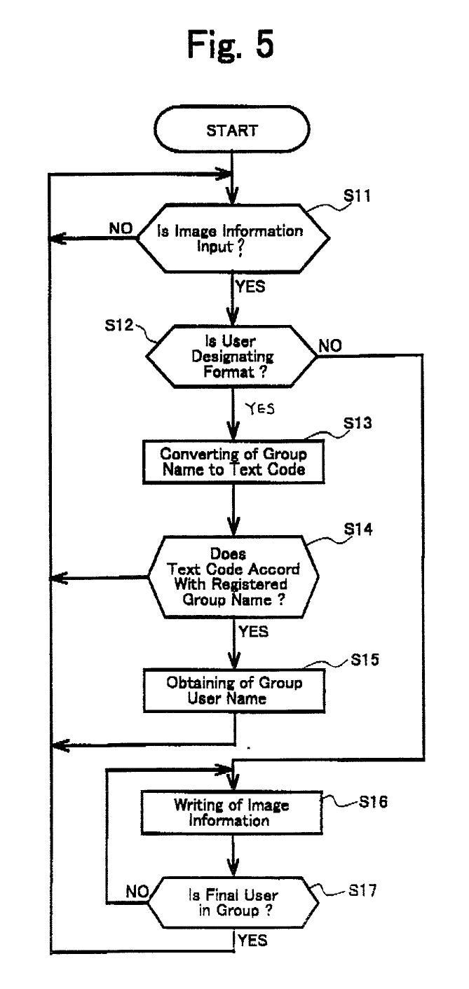

Hereinbelow, a second example of an operation executed in the present invention is explained referring to FIG. 5. As illustrated in FIG. 5, in a first step S11 the system controlling section 11 may monitor whether image information is input through the image information inputting device 1b during the earlier mentioned waiting time.

During the waiting time, a user may set on the image information inputting device 1b both (1) a format image sheet P having a group name or the like (instead of the user name of FIG. 4) as a first page of a stack of original documents and (2) one or more original documents to be read successively attached to the format image sheet P. An image inputting operation is started by depressing a start key provided on the image information inputting device 1b. As in the previous example, a pair of marks M may indicate that a group name is between the marks M.

When the system controlling section 11 receives input image information in step S11, i.e. Yes in step S11, the system controlling section 11 may transfer the input image information to the image information determining section 13 so that the image information determining section 13, in step S12, may determine if the marks M are included in the image information.

If the system controlling section 11 receives information indicating the inclusion of the marks M, and determines that the image information includes format image information including the group name in step S12, i.e. Yes in step S12, the system controlling section 11 may then order the image information determining section 13 to recognize the group name. The image information determining section 13 may recognize the group name put between the marks M using the above-mentioned conventional character recognizing method, and convert the group name into a corresponding text code.

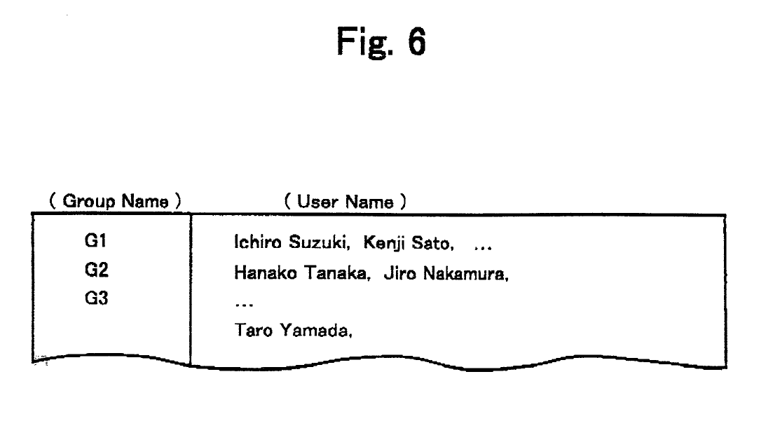

The image information determining section 13 may thereafter transfer the text code to the system controlling section 11. The system controlling section 11 may, in step S14, then determine if the above-mentioned group name has been registered. A plurality of group names may have been previously registered in a user table as illustrated in FIG. 6, and such a user table may have been copied from, e.g., a hard disk constituting the image information storing section 14 to the RAM 16. Thus, the system controlling section 11 may execute the determination in step S14 after retrieving a prescribed group name from the user table of FIG. 6.

As a result, if it is determined that the group name has been registered in step S14, i.e.

Yes in step S14, in step S15 the system controlling section 11 may obtain one or more user names (group member's names) included in the group name from the user table of FIG. 6.

Then, the system controlling section 11 may thereafter return to step S11 after storing the one or more user names in a prescribed area of the RAM 16. If it is determined that the group name has not been registered, i.e. No in step S14, a mark indicating such a determination may be displayed on a display (not shown), and the process returns to step S11.

After the operation returns to step S11 after reading of the format information sheet P, image information of the original document following the format information sheet P is read.

At this time, since the format information sheet P including the mark has already been read, the mark M is not detected by the system controlling section 11 in step S2, i.e. No in step S12, and it is thereby determined that the image information read is original document information to be stored in the information server 1a. The operation then proceeds to step S16.

The system controlling section 11 may thereafter obtain a folder number for a first user name from the user table as illustrated in FIG. 4 referring to the user name information stored in the prescribed area of the RAM 16. The system controlling section 11 may thereafter in step S16 store the image information read from the original document in an area of the image information storing section 14 which corresponds to the obtained folder number.

This operation will be repeated for each user of the user group. More particularly, after the image information read from the original document is stored in a folder corresponding to a user of the user group, the operation then proceeds to step S17 in which it is determined whether the user is a final member of the user group.

That is, if the above-mentioned user is not a first member of the user group, i.e. No in step S17, the same image information is written in a folder for a next user of the user group also in step S16. If the image information has been written in folders for all of the user names of the user group, i.e. Yes in step S17, such a writing operation is completed. A user may then operate the client terminal device 2 to read the image information stored in a prescribed folder having a prescribed folder number corresponding to a user name by designating the user name or folder number.

According to the second example, the operator is not required to go to and return from the information server 1a and the image information inputting device 1b, which may be located apart from the information server 1a, or to go between the client terminal device 2 and the image information inputting device 1b. Further, a key depressing operation for inputting the user name may not be required, and the same image information may be easily delivered to a plurality of users.

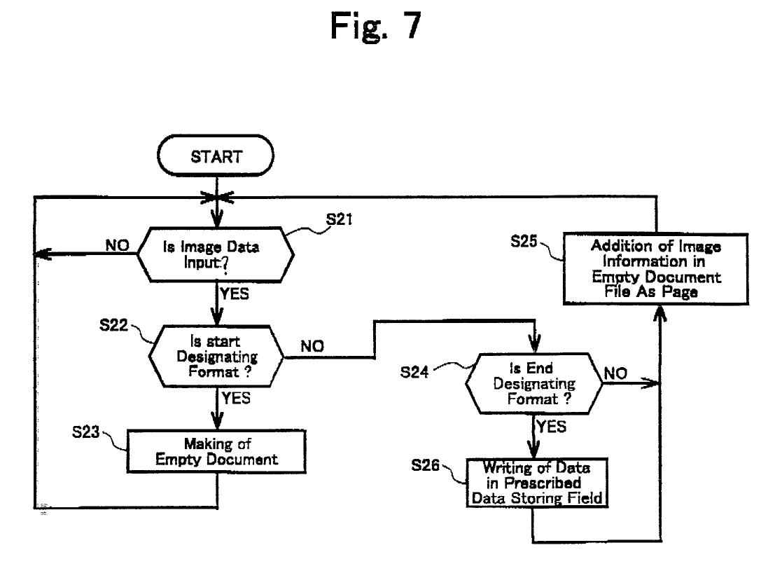

Hereinbelow, a third example of an operation in the present invention is explained referring to FIG. 7. As illustrated therein, in a first step S21 the system controlling section 11 may monitor input of image information through the image information inputting device 1b during a waiting time similarly as mentioned in the above-described operations.

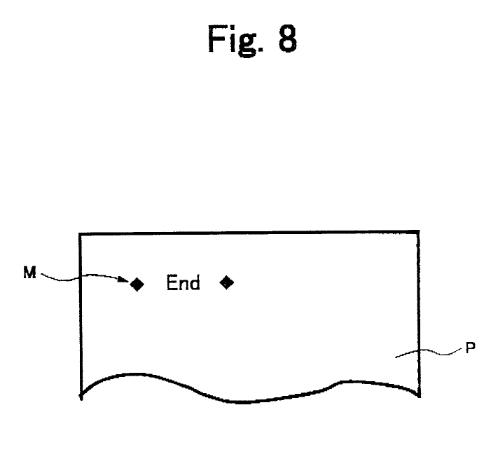

During the waiting time, a user may set on the image information inputting device 1b each of (1) a format image sheet P having a user name or the like as a first page of a stack of original documents, (2) one or more original documents successively attached to the format image sheet P, and (3) another format image information sheet P having a document end information as illustrated in FIG. 8 as a last page of the stack of the original documents. An image inputting operation is started by depressing a start key provided on the image information inputting device 1b.

When the system controlling section 11 receives first image information input by, e.g., a scanner in step S21, i.e. Yes in step S21, the system controlling section 13 may transfer the image information to the image information determining section 13 so that the image information determining section 13 may determine if marks M are included in the image information.

If the system controlling section 11 receives information indicating inclusion of the marks M, it may in step S22 determine whether the image information is of the format image sheet P including the user name, and regard the image information as document start information if Yes in step S22. The document start information may be used for separating a newly formed electronic document image file from a previous electronic document image file. The system controlling section 11 may then order the image information determining section 13 to recognize the user name. The image information determining section 13 may then recognize the user name put between the marks M using a character recognizing method, and convert the user name into a corresponding text code.

The image information determining section 13 may thereafter transfer the text code to the system controlling section 11. The system controlling section 11 may then obtain the user name, and also obtain a corresponding file number from a file managing section (not shown) included in the server, as discussed above. Then, in step S23 the system controlling section 11 may thereafter form an empty electronic document only having information of a date or the like in a prescribed area of the RAM 16 after adding the file number to a document list which generally handles a plurality of electronic document files. The document list may list numbers of documents, document making dates, and those times of the day.

The process may thereafter return to step S21. When image information is input by the scanner again in step S21, i.e. Yes in step S21, and if it is determined that the image information does not include the format image having the document start information in step S22, i.e. No in step S22, it is then determined in step S24 whether the image information includes the document end information as shown in FIG. 8. If the image information further does not include the format image having the document end information of FIG. 8 as determined in step S24, i.e. No in step S24, the system controlling section 11 may determine that the image information input is original document information to be stored in the information server 1a.

The system controlling section 11 may then in step S25 store the image information in the previously empty electronic document formed in the RAM 16 as an electronic document file constituting one page of the image information. If image information of following pages of the original document is input in step S21, i.e. No in step S21, and it is determined that the image information of the following pages is not related to the format image including the document end information in step S24, i.e. No in step S24, the addition of image information of the next pages of the original document to the electronic document is repeated in step S25.

If it is determined that the image information includes the format image information having the document end information of FIG. 8 in step S24, i.e. Yes in step S24, the system controlling section 11 may in step S26 store the electronic document formed in the RAM 16 in a prescribed folder allocated for the user as an electronic document file.

According to the third example of an operation in the present invention, the electronic document may be handled unit by unit. Namely, the user may read the electronic document by designating a prescribed file number of the electronic document file formed in his or her folder referring to the document list.

Further, a plurality of electronic documents may be continuously stored during one operation, if one or more format image sheets P including document end information and user information are respectively inserted within the plurality of original documents.

Further, in the above-mentioned example, another format image sheet P having a message “start” between marks M can be used for the format image sheet P as illustrated in FIG. 3. Further, the group information can be used for the user information P having document start information.

Obviously, numerous additional modifications and variations of the present invention are possible in light of the above teachings. It is therefore to be understood that within the scope of the appended claims, the present invention may be practiced otherwise than as specifically described herein.

This document is based on Japanese priority document 10-179731, filed in the Japanese Patent Office on Jun, 11, 1998, the entire contents of which are incorporated herein by reference.

1. A network system including a plurality of users connected through a plurality of client terminal devices connected to a network, comprising:
an image information storing device connected to the network, and configured to store image information for the plurality of users;
an image information inputting device connected to the image information storing device, and configured to input image information including both document image information to be stored in the image information storing device and format image information;
an image information determining device configured to determine if the image information input by the image information inputting device includes the format image information; and
wherein the image information storing device is further configured to store the document image information in the image information storing device based on the format image information.

2. A network system as claimed in claim 1, wherein:
the format image information includes at least one of user information and user group information.

3. A network system as claimed in claim 1, wherein:
said image information storing device is further configured to store image information having a plurality of pages of original documents as one image file.

4. A network system as claimed in claim 2, wherein:
said image information determining device is further configured to determine if the format image information input by the image information inputting device is related to document start information and document end information; and
said image information storing device is further configured to store image information read from original documents during a time period between inputting operations for the document start information and the document end information as one image file.

5. A network system an claimed in claim 3, wherein:
said image information determining device is further configured to determine if the format image information input by the image information inputting device is related to document start information and document end information; and
said image information storing device is further configured to store image information read from original documents during a time period between inputting operations for the document start information and the document end information as one image file.

6. A network system as claimed in claim 2, wherein:
said image information determining device is further configured to determine if the format image information input by the image information inputting device includes document end information; and
said image information storing device is further configured to store image information read from original documents during a time period between inputting operations for the image information and the document end information as one image file.

7. A network system as claimed in claim 3, wherein:
said image information determining device is further configured to determine if the format image information input by the image information inputting device includes document end information; and
said image information storing device is further configured to store image information read from original documents during a time period between inputting operations for the image information and the document end information as one image file.

8. A network system including a plurality of users connected through a plurality of client terminal devices connected to a network, comprising:
storing means for storing image information for the plurality of users;
inputting means for inputting image information including both of document image information to be stored in the image information storing device and format image information;
determining means for determining if the input information input to the inputting means includes the format image information; and
wherein the storing means further stores the document image information based on the format image information.

9. A network system as claimed in claim 8, wherein:
the format image information includes at least one of user information and user group information.

10. A network system as claimed in claim 8, wherein:
said storing means stores image information having a plurality of pages of original documents as one image file.

11. A network system as claimed in claim 9, wherein:
said determining means further determines if the format image information input to the inputting means is related to document start information and document end information; and
said storing means further stores image information from original documents during a time period between inputting operations for the document start information and the document end information as one image file.

12. A network system as claimed in claim 10, wherein:
said determining means further determines if the format image information input to the inputting means is related to document start information and document end information; and
said storing means further stores image information from original documents during a time period between inputting operations for the document start information and the document end information as one image file.

13. A network system as claimed in claim 9, wherein:
said determining means further determines if the format image information input to the inputting means includes document end information; and
said storing means further stores image information input from original documents during a time period between inputting operations for the image information and the document end information as one image file.

14. A network system as claimed in claim 10, wherein:
said determining means further determines if the format image information input to the inputting means includes document end information; and
said storing means further stores image information input from original documents during a time period between inputting operations for the image information and the document end information as one image file.

15. A method for controlling a network system including a plurality of users connected through a plurality of client terminal devices connected to a network, comprising the steps of:
storing image information for the plurality of users;
inputting image information including both document image information to be stored and format image information;
determining if the input image information includes the format image information; and
storing the document image information in the image information storing device based on the format image information.

16. A method for controlling a network system as claimed in claim 15, wherein:
the format image information includes at least one of user information or user group information.

17. A method of controlling a network system as claimed in claim 15, wherein:
in said storing step image information having a plurality of pages of original documents is stored as one image file.

18. A method of controlling a network system as claimed in claim 16, wherein:
in said determining step it is further determined if the format image information is related to document start information and document end information; and
in said storing step image information read from original documents is stored during a time period between inputting operations for the document start information and the document end information as one image file.

19. A method of controlling a network system as claimed in claim 17, wherein:
in said determining step it is further determined if the format image information is related to document start information and document end information; and
in said storing step image information read from original documents is stored during a time period between inputting operations for the document start information and the document end information as one image file.

20. A method of controlling a network system as claimed in claim 16, wherein:
in said determining step it is further determined if the format image information includes document end information; and
in said image storing step image information read from original documents is stored during a time period between inputting operations for the image information and the document end information as one image file.

21. A method of controlling a network system as claimed in claim 17, wherein:
in said determining step it is further determined if the format image information includes document end information; and
in said image storing step image information read from original documents is stored during a time period between inputting operations for the image information and the document end information as one image file.
